(19) United States
(12) Patent Application Publication
(10) Pub. No.: US 2022/0279832 A1
(43) Pub. Date: Sep. 8, 2022

(54) AIR FRYING OF SNACK FOOD PRODUCTS

(71) Applicant: Campbell Soup Company, Camden, NJ (US)

(72) Inventors: Rasheed Mohammed, Sicklerville, NJ (US); Azalenah Shah, Stamford, CT (US); Karthick Athmaram, Fairfield, CT (US)

(21) Appl. No.: 17/575,199

(22) Filed: Jan. 13, 2022

Related U.S. Application Data
(60) Provisional application No. 63/138,066, filed on Jan. 15, 2021.

(51) Int. Cl. A23L 33/20; A23P 20/17; A23L 19/18; A23L 5/10

(52) U.S. Cl. CPC A23L 33/20; A23P 20/17; A23L 19/18; A23L 5/11; A23L 5/17

(57) ABSTRACT

Embodiments herein relate to air-fried snack food products and related methods. In an embodiment, a method of preparing a reduced fat fried snack product is included. The method can include preparing discrete units of a snack product, par frying the snack product in an oil fryer, wherein par frying the snack product in the oil fryer reduces moisture in the snack product to approximately 2 to 8 weight percent, and frying the snack product in a centrifuge air fryer, wherein frying the snack product in the centrifuge air fryer reduces moisture in the snack product to 1.5 to 2.5 weight percent and reduces fat content of the snack product to 12 to 38 weight percent. Other embodiments are also included herein.

This application claims the benefit of U.S. Provisional Application No. 63/138,066, filed Jan. 15, 2021, the content of which is herein incorporated by reference in its entirety.

### FIELD

Embodiments herein relate to snack food products. More specifically, embodiments herein relate to air-fried snack food products and related methods.

### BACKGROUND

Snack foods are a significant segment of the overall food market. Sweet and savory snacks include crisps and chips, extruded snacks, nut-based snacks, fruit snacks, and the like.

Various sensory properties are important to consumers depending on the specific type of snack food. Many snack foods are fried, giving them a desirably crispy and sometimes crunchy texture. Unfortunately, fried snacks generally include a very high fat content. Therefore, some consumers choose baked snacks in part because of lower fat content. However, baked snacks do not have the same desirable sensory properties as their fried counterparts.

Further, many consumers desire intense flavors in their snack foods. However, adding large amounts of seasoning compositions generally leads to undesirably increasing the fat/calorie content of the snack product.

### SUMMARY

Embodiments herein relate to air-fried snack food products and related methods. In a first aspect, a method of preparing a reduced fat fried snack product is included. The method can include preparing discrete units of a snack product, par frying the snack product in an oil fryer, wherein par frying the snack product in the oil fryer reduces moisture in the snack product to approximately 2 to 8 weight percent, and frying the snack product in a centrifuge air fryer, wherein frying the snack product in the centrifuge air fryer reduces moisture in the snack product to 1.5 to 2.5 weight percent and reduces fat content of the snack product to 12 to 38 weight percent.

In a second aspect, in addition to one or more of the preceding or following aspects, or in the alternative to some aspects, the residence time in the oil fryer can be from 2.5 to 9 minutes.

In a third aspect, in addition to one or more of the preceding or following aspects, or in the alternative to some aspects, the residence time in the centrifuge air fryer can be 0.5 to 8 minutes.

In a fourth aspect, in addition to one or more of the preceding or following aspects, or in the alternative to some aspects, the residence time in the centrifuge air fryer can be greater than the residence time in the oil fryer.

In a fifth aspect, in addition to one or more of the preceding or following aspects, or in the alternative to some aspects, a gas temperature within the centrifuge air fryer can be from 250 to 500 degrees Fahrenheit.

In a sixth aspect, in addition to one or more of the preceding or following aspects, or in the alternative to some aspects, a gas temperature within the centrifuge air fryer can be from 360 to 400 degrees Fahrenheit.

In a seventh aspect, in addition to one or more of the preceding or following aspects, or in the alternative to some aspects, a gas temperature within the centrifuge air fryer can be set at a first temperature for a first time period and can be set at a second temperature for a second time period.

In an eighth aspect, in addition to one or more of the preceding or following aspects, or in the alternative to some aspects, a transition between the first temperature and the second temperature can be a ramp.

In a ninth aspect, in addition to one or more of the preceding or following aspects, or in the alternative to some aspects, a transition between the first temperature and the second temperature can be a step change.

In a tenth aspect, in addition to one or more of the preceding or following aspects, or in the alternative to some aspects, an oil temperature in the oil fryer can be from 265 to 400 degrees Fahrenheit.

In an eleventh aspect, in addition to one or more of the preceding or following aspects, or in the alternative to some aspects, wherein preparing discrete units of the snack product further includes slicing a food material.

In a twelfth aspect, in addition to one or more of the preceding or following aspects, or in the alternative to some aspects, the food material includes a potato.

In a thirteenth aspect, in addition to one or more of the preceding or following aspects, or in the alternative to some aspects, the snack product can be a potato chip.

In a fourteenth aspect, in addition to one or more of the preceding or following aspects, or in the alternative to some aspects, wherein preparing discrete units of the snack product further includes sheeting and cutting a food material.

In a fifteenth aspect, in addition to one or more of the preceding or following aspects, or in the alternative to some aspects, the food material includes a masa-based dough.

In a sixteenth aspect, in addition to one or more of the preceding or following aspects, or in the alternative to some aspects, the snack product can be a tortilla chip.

In a seventeenth aspect, in addition to one or more of the preceding or following aspects, or in the alternative to some aspects, a gas within the centrifuge air fryer contains less than 1 percent by volume oxygen.

In an eighteenth aspect, in addition to one or more of the preceding or following aspects, or in the alternative to some aspects, a gas within the centrifuge air fryer contains at least 95% by volume nitrogen.

In a nineteenth aspect, in addition to one or more of the preceding or following aspects, or in the alternative to some aspects, a moisture content in a gas in the centrifuge air fryer can be less than atmospheric.

In a twentieth aspect, in addition to one or more of the preceding or following aspects, or in the alternative to some aspects, an interior of the centrifuge air fryer can be under vacuum.

In a twenty-first aspect, in addition to one or more of the preceding or following aspects, or in the alternative to some aspects, the method can further include applying a seasoning composition in the centrifuge air fryer.

In a twenty-second aspect, in addition to one or more of the preceding or following aspects, or in the alternative to some aspects, the method can further include applying a seasoning composition after frying the snack product in the centrifuge air fryer.

In a twenty-third aspect, in addition to one or more of the preceding or following aspects, or in the alternative to some aspects, the method can further include precooking a component of the snack product prior to par frying the snack product in the oil fryer.

In a twenty-fourth aspect, in addition to one or more of the preceding or following aspects, or in the alternative to some aspects, the centrifuge air fryer operates at a drum speed of 120 to 300 rpm.

In a twenty-fifth aspect, in addition to one or more of the preceding or following aspects, or in the alternative to some aspects, the centrifuge air fryer operates at a gas flow rate of 1.0 to 4.0 cfm.

In a twenty-sixth aspect, in addition to one or more of the preceding or following aspects, or in the alternative to some aspects, the method can further include exposing the discrete units of the snack product to a pulse electric field prior to par frying the snack product in the oil fryer.

In a twenty-seventh aspect, in addition to one or more of the preceding or following aspects, or in the alternative to some aspects, the centrifuge air fryer includes a microwave or RF emitter.

In a twenty-eighth aspect, in addition to one or more of the preceding or following aspects, or in the alternative to some aspects, the snack product can have a starch content of greater than 50 wt. % after the operation of frying the snack product in the centrifuge air fryer.

In a twenty-ninth aspect, in addition to one or more of the preceding or following aspects, or in the alternative to some aspects, the snack product can have less than 600 pores per millimeter squared of surface area after the operation of frying the snack product in the centrifuge air fryer.

In a thirtieth aspect, in addition to one or more of the preceding or following aspects, or in the alternative to some aspects, the snack product can have a mean lipid droplet size of less than 100 micrometers squared on the surface thereof after the operation of frying the snack product in the centrifuge air fryer.

In a thirty-first aspect, a method of preparing a reduced fat fried snack product is included. The method can include preparing discrete units of a snack product, par frying the snack product in an oil fryer, wherein par frying the snack product in the oil fryer reduces moisture in the snack product to approximately 2 to 8 weight percent, frying the snack product in a centrifuge air fryer, wherein frying the snack product in the centrifuge air fryer reduces moisture in the snack product to 1.5 to 2.5 weight percent and reduces fat content of the snack product to 12 to 38 weight percent, and applying a seasoning composition to the snack product, wherein applying a seasoning composition to the snack product increases the fat content of the snack product to 33 to 38 weight percent.

In a thirty-second aspect, in addition to one or more of the preceding or following aspects, or in the alternative to some aspects, the residence time in the oil fryer can be from 2.5 to 9 minutes.

In a thirty-third aspect, in addition to one or more of the preceding or following aspects, or in the alternative to some aspects, the residence time in the centrifuge air fryer can be 0.5 to 8 minutes.

In a thirty-fourth aspect, in addition to one or more of the preceding or following aspects, or in the alternative to some aspects, the residence time in the centrifuge air fryer can be greater than the residence time in the oil fryer.

In a thirty-fifth aspect, in addition to one or more of the preceding or following aspects, or in the alternative to some aspects, a gas temperature within the centrifuge air fryer can be from 250 to 500 degrees Fahrenheit.

In a thirty-sixth aspect, in addition to one or more of the preceding or following aspects, or in the alternative to some aspects, a gas temperature within the centrifuge air fryer can be from 360 to 400 degrees Fahrenheit.

In a thirty-seventh aspect, in addition to one or more of the preceding or following aspects, or in the alternative to some aspects, a gas temperature within the centrifuge air fryer can be set at a first temperature for a first time period and can be set at a second temperature for a second time period.

In a thirty-eighth aspect, in addition to one or more of the preceding or following aspects, or in the alternative to some aspects, a transition between the first temperature and the second temperature can be a ramp.

In a thirty-ninth aspect, in addition to one or more of the preceding or following aspects, or in the alternative to some aspects, a transition between the first temperature and the second temperature can be a step change.

In a fortieth aspect, in addition to one or more of the preceding or following aspects, or in the alternative to some aspects, an oil temperature in the oil fryer can be from 265 to 400 degrees Fahrenheit.

In a forty-first aspect, in addition to one or more of the preceding or following aspects, or in the alternative to some aspects, wherein preparing discrete units of the snack product further includes slicing a food material.

In a forty-second aspect, in addition to one or more of the preceding or following aspects, or in the alternative to some aspects, the food material includes a potato.

In a forty-third aspect, in addition to one or more of the preceding or following aspects, or in the alternative to some aspects, the snack product can be a potato chip.

In a forty-fourth aspect, in addition to one or more of the preceding or following aspects, or in the alternative to some aspects, wherein preparing discrete units of the snack product further includes sheeting and cutting a food material.

In a forty-fifth aspect, in addition to one or more of the preceding or following aspects, or in the alternative to some aspects, the food material includes a masa-based dough.

In a forty-sixth aspect, in addition to one or more of the preceding or following aspects, or in the alternative to some aspects, the snack product can be a tortilla chip.

In a forty-seventh aspect, in addition to one or more of the preceding or following aspects, or in the alternative to some aspects, a gas within the centrifuge air fryer contains less than 1 percent by volume oxygen.

In a forty-eighth aspect, in addition to one or more of the preceding or following aspects, or in the alternative to some aspects, a gas within the centrifuge air fryer contains at least 95% by volume nitrogen.

In a forty-ninth aspect, in addition to one or more of the preceding or following aspects, or in the alternative to some aspects, a moisture content in a gas in the centrifuge air fryer can be less than atmospheric.

In a fiftieth aspect, in addition to one or more of the preceding or following aspects, or in the alternative to some aspects, an interior of the centrifuge air fryer can be under vacuum.

In a fifty-first aspect, in addition to one or more of the preceding or following aspects, or in the alternative to some aspects, the method can further include precooking a component of the snack product prior to par frying the snack product in the oil fryer.

In a fifty-second aspect, in addition to one or more of the preceding or following aspects, or in the alternative to some aspects, the centrifuge air fryer operates at a drum speed of 120 to 300 rpm.

In a fifty-third aspect, in addition to one or more of the preceding or following aspects, or in the alternative to some aspects, the centrifuge air fryer operates at a gas flow rate of 1.0 to 4.0 cfm.

In a fifty-fourth aspect, in addition to one or more of the preceding or following aspects, or in the alternative to some aspects, the method can further include exposing the discrete units of the snack product to a pulse electric field prior to par frying the snack product in the oil fryer.

In a fifty-fifth aspect, in addition to one or more of the preceding or following aspects, or in the alternative to some aspects, the centrifuge air fryer includes a microwave or RF emitter.

In a fifty-sixth aspect, in addition to one or more of the preceding or following aspects, or in the alternative to some aspects, the snack product can have a starch content of greater than 50 wt. % after the operation of frying the snack product in the centrifuge air fryer.

In a fifty-seventh aspect, in addition to one or more of the preceding or following aspects, or in the alternative to some aspects, the snack product can have less than 600 pores per millimeter squared of surface area after the operation of frying the snack product in the centrifuge air fryer.

In a fifty-eighth aspect, in addition to one or more of the preceding or following aspects, or in the alternative to some aspects, the snack product can have a mean lipid droplet size of less than 100 micrometers squared on the surface thereof after the operation of frying the snack product in the centrifuge air fryer.

In a fifty-ninth aspect, a method of preparing a reduced fat fried snack product can be included. The method can include preparing discrete units of a snack product and frying the snack product in a centrifuge air fryer, wherein frying the snack product in a centrifuge air fryer reduces moisture in the snack product to 1.5 to 2.5 weight percent and reduces fat content of the snack product to 12 to 38 weight percent.

In a sixtieth aspect, an air fried snack product can be included having moisture of 1.5 to 2.5 wt. %, fat content of 12 to 38 wt. %, a starch content of greater than 50 wt. %, less than 600 pores per mm2 of surface area, and a mean lipid droplet size of less than 100 mm² on the surface thereof.

In a sixty-first aspect, in addition to one or more of the preceding or following aspects, or in the alternative to some aspects, can include a potato chip.

In a sixty-second aspect, in addition to one or more of the preceding or following aspects, or in the alternative to some aspects, having a starch content of 50 wt. % to 70 wt. %.

In a sixty-third aspect, in addition to one or more of the preceding or following aspects, or in the alternative to some aspects, having from 100 to 600 pores per mm² of surface area.

In a sixty-fourth aspect, in addition to one or more of the preceding or following aspects, or in the alternative to some aspects, having a mean lipid droplet size of 50 to 100 mm² on the surface thereof.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic view of components used to execute operations in accordance with various embodiments herein.

FIG. 2 is a schematic view of a centrifuge air fryer in accordance with various embodiments herein.

FIG. 3 is a schematic view of centrifuge air fryer in accordance with various embodiments herein.

FIG. 4 is a schematic view of centrifuge air fryer in accordance with various embodiments herein.

FIG. 5 is a plan view of a snack product in accordance with various embodiments herein.

FIG. 6 is a cross-sectional view of a snack product as taken along line 6-6′ of FIG. 5 in accordance with various embodiments herein.

FIG. 7 is a cross-sectional view of a snack product portion in accordance with various embodiments herein.

FIG. 8 is a graph showing moisture content of potato chips versus time for an embodiments of the air frying process herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

Embodiments herein relate to snack products and methods of preparing the same that can achieve the desirable sensory properties of fried snacks and/or intense flavor properties while offering reduced fat content in comparison with otherwise similar traditional fried snack food products.

In some embodiments, a method of preparing a reduced fat fried snack product is included. The method can include preparing discrete units of a snack product, par frying the snack product in an oil fryer, wherein par frying the snack product in the oil fryer reduces moisture in the snack product to approximately 2 to 8 weight percent; and frying the snack product in a centrifuge air fryer, wherein frying the snack product in the centrifuge air fryer reduces moisture in the snack product to 1.5 to 2.5 weight percent and reduces fat content of the snack product to 12 to 38 weight percent.

In other embodiments herein, a method of preparing a fried snack product is included. The method can include preparing discrete units of a snack product, par frying the snack product in an oil fryer, and frying the snack product in a centrifuge air fryer. The method can also include applying a seasoning composition to the snack product, wherein applying a seasoning composition to the snack product increases the fat content of the snack product, such as to 33 to 38 weight percent in some embodiments.

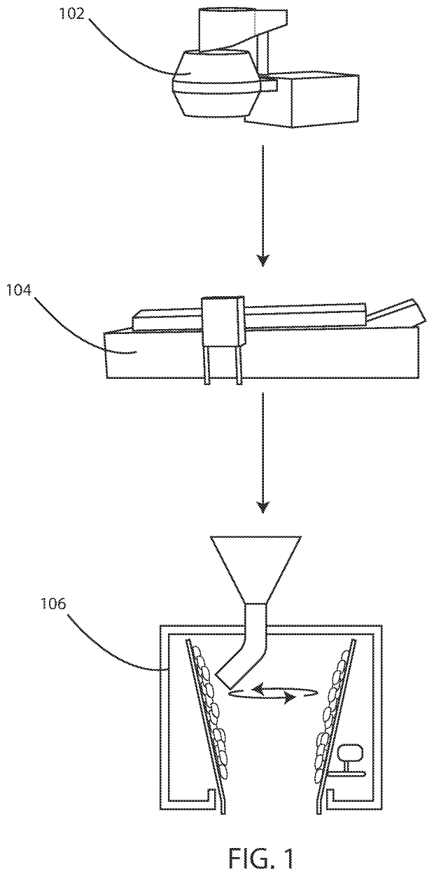

Referring now to FIG. 1, a schematic view of components used to execute various operations is shown in accordance with various embodiments herein. FIG. 1 shows a preparation unit 102. The preparation unit 102 can be used to perform various preparatory operations. The specific operations performed can depend on the nature of the particular snack food being prepared. Also, it will be appreciated that, while a single machine is schematically depicted in this view, many different machines can be used in preparatory steps herein. That is, the preparation unit 102 can be representative of a plurality of different machines used for various preparation operations. The preparation unit 102 and/or machines thereof can perform operations including, but not limited to, washing, sorting, slicing, cutting, mixing, extruding, sheeting, pre-cooking, and the like. In some embodiments, the snack food product can be exposed to a pulse electric field or another electromagnetic field as part of a preparatory operation.

FIG. 1 also shows an oil fryer 104. After preparatory operations are performed, the oil fryer 104 can be used to par fry snack food products herein. Various oil fryers can be used herein. In some embodiments, the oil fryer 104 can include a kettle or cooking basin that is filled with a food grade oil. The oil fryer 104 can include one or more heating elements and a thermostat in order to heat the oil up to a desired cooking temperature and/or maintain it at a desired temperature. The temperature of the oil can vary based on various factors including the particular snack food product being fried and smoke point of the particular oil being used.

In some embodiments, the temperature of the oil within the oil fryer 104 can be greater than or equal to 250° F., 260° F., 270° F., 280° F., 290° F., 300° F., 320° F., 340° F., 360° F., 380° F., or 400° F. In some embodiments, the temperature can be less than or equal to 370° F., 355° F., 340° F., 330° F., 320° F., or 310° F. In some embodiments, the temperature can fall within a range of 250° F. to 370° F., or 260° F. to 355° F., or 270° F. to 340° F., or 280° F. to 330° F., or 290° F. to 320° F. In some embodiments, the temperature of the oil within the oil fryer 104 can be from about 265 to 400 degrees Fahrenheit. In some embodiments, however, such as if the oil fryer is under a vacuum, even lower temperatures can be used. For example, if under vacuum, the temperature could be as low as 320 degrees Fahrenheit or lower. The oil fryer 104 can be configured to operate in batch or continuous operating modes. The snack food product can be partially or fully immersed within the heated oil of the oil fryer 104. Various oils can be used including, but not limited to, vegetable oil of various types including safflower oil, sunflower oil, grape seed oil, avocado oil, canola oil, olive oil, peanut oil, palm oil, coconut oil, corn oil, and the like. In some embodiments, the oil composition can include one or more non-oil components such as flavorings, colorings, functional additives (such as antioxidants), or the like. In some embodiments, various components including for example flavorings, colorings, functional additives (such as antioxidants), or the like can be sprayed on before, during or after any process steps described herein.

Cooking performed by the oil fryer 104 can serve to reduce the moisture content of the snack food product cooked therein. If the moisture content is not sufficiently low after the oil frying operation, it can lead to more product defects. Also, if the moisture content is not sufficiently low, the product can be difficult to handle. In some embodiments, the moisture content can be reduced to less than or equal to 8, 7, 6, 5, 4, 3, 2, or 1 weight percent, or can be an amount falling within a range between any of the foregoing. By way of example, cooking performed by the oil fryer 104 can reduce the moisture content to approximately 2 to 8 weight percent. Cooking performed by the oil fryer 104 also results in oil uptake by the snack food product. Thus, cooking performed by the oil fryer 104 can raise the oil or lipid content of the snack food product to a fat content greater than or equal to 20, 23, 26, 29, 32, or 35 weight percent. In some embodiments, the fat content can be less than or equal to 40, 39, 38, 37, 36, or 35 weight percent. In some embodiments, the fat content can fall within a range of 20 to 40 weight percent, or 23 to 39 weight percent, or 26 to 38 weight percent, or 29 to 37 weight percent, or 32 to 36 weight percent. In some embodiments, cooking performed by the oil fryer 104 increases the fat content of the snack product to 33 to 38 weight percent.

The residence time of the snack food product in the oil fryer 104 can vary. In some embodiments, the residence time can be greater than or equal to 2.5, 3.0, 3.5, or 4.0 minutes. In some embodiments, the residence time can be less than or equal to 9, 8, 7, 6, 6.5, 5.5, 4.5, or 4.0 minutes. In some embodiments, the residence time can fall within a range of 2.5 to 9 minutes, or 3.0 to 5.5 minutes, or 3.5 to 4.5 minutes. In some embodiments, the residence time in the oil fryer 104 can be about 3.5 to 5.5 minutes.

FIG. 1 also shows a centrifuge air fryer 106. The centrifuge air fryer 106 can be used to further cook the snack food product after it has left the oil fryer 104. The centrifuge air fryer 106 can include a heated gaseous environment that further cooks the snack food product. In some embodiments, the temperature of the gaseous environment within the centrifuge air fryer 106 can be greater than or equal to 250, 262, 275, 288, 300, 312, 325, 338, 350, 362, or 375 degrees Fahrenheit. In some embodiments, the temperature of the gaseous environment can be less than or equal to 500, 488, 475, 462, 450, 438, 425, 412, 400, 388, or 375 degrees Fahrenheit. In some embodiments, the temperature of the gaseous environment can fall within a range of 250 to 500 degrees Fahrenheit, or 275 to 475 degrees Fahrenheit, or 300 to 450 degrees Fahrenheit, or 325 to 425 degrees Fahrenheit, or 360 to 400 degrees Fahrenheit.

Cooking with the centrifuge air fryer 106 can reduce the moisture content of the snack food product. In some embodiments, the moisture content can be reduced to less than or equal to 5.0, 4.5, 4.0, 3.5, 3.0, 2.5, 2.0, 1.5, or 1.0 weight percent, or can be an amount falling within a range between any of the foregoing. The centrifuge air fryer 106 can be used to reduce the moisture content to 1.5 to 2.5 weight percent.

Processing by the centrifuge air fryer 106 also results in drawing off oil held by the snack food product. Thus, cooking performed by the centrifuge air fryer 106 can lower the oil or lipid content of the snack food product. In some embodiments, cooking performed by the centrifuge air fryer 106 can lower the oil or lipid content of the snack food product to less than or equal to 30, 29, 28, 27, 26, 25, 24, 23, 22, 21, 20, 19, 18, 17, 16, 15, 14, 13, or 12 weight percent, or can be an amount falling within a range between any of the foregoing. In some embodiments, cooking performed by the centrifuge air fryer 106 can lower the oil or lipid content of the snack food product to 12 to 38 percent.

The residence time of the snack food product in the centrifuge air fryer 106 can vary. In some embodiments, the residence time in the centrifuge air fryer 106 can be greater than or equal to 0.5, 1, 1.5, 2, 2.5, 3, 3.5, 4, 4.5, 5, 5.5, or 6 minutes. In some embodiments, the residence time can be less than or equal to 8.0, 7.5, 7.0, 6.5, or 6.0 minutes. In some embodiments, the residence time can fall within a range of 0.5 to 8.0 minutes, or 4.5 to 7.5 minutes, or 5.0 to 7.0 minutes, or 5.5 to 6.5 minutes, or can be about 6.0 minutes. In some embodiments, the residence time in the centrifuge air fryer 106 can be about 5 to 7 minutes. In various embodiments herein, the residence time in the centrifuge air fryer can be greater than the residence time in the oil fryer.

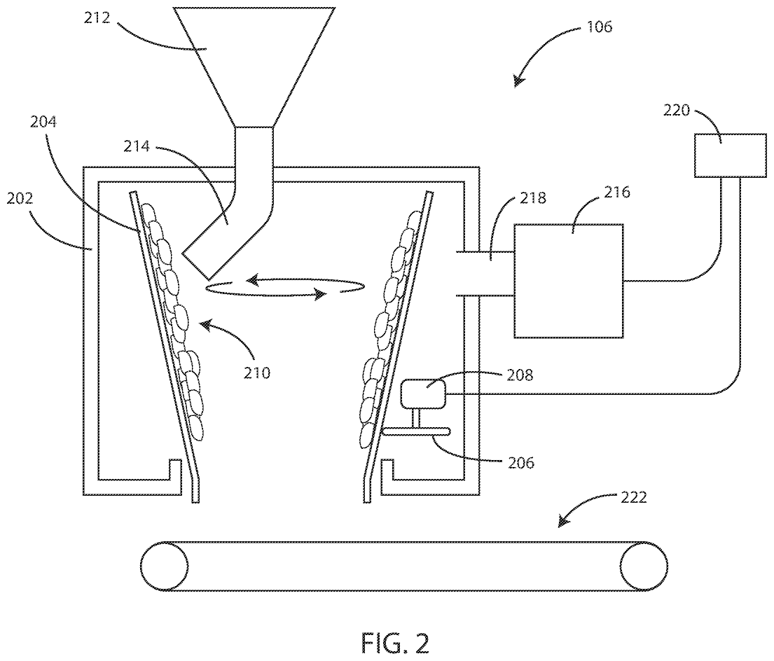

Referring now to FIG. 2, a schematic view of a centrifuge air fryer 106 is shown in accordance with various embodiments herein. The centrifuge air fryer 106 includes a housing 202. The centrifuge air fryer 106 also includes a rotating basket 204 that can be disposed at least partially within the housing 202. The rotating basket 204 can be formed of various materials including polymers, metals, composites, and the like. The rotating basket 204 can include, in some embodiments, a surface with holes or apertures in order to selectively allow oil to pass through from the insider surface (where the snack food products are held) to the outside as the rotating basket 204 rotates, but retain the snack food products on the inside.

The rotating basket 204 can be mounted on bearings or bushing or on or under a rotating shaft or platform in order to allow it to rotate within the housing 202. The centrifuge air fryer 106 also includes a drive mechanism 206, such as a gear or contact wheel and a drive motor 208 (which can be an electric motor or another type of motor) in order to rotate the rotating basket 204.

In some embodiments, the rotating basket 204 can rotate at a speed can be greater than or equal to 120 rpm, 128 rpm, 136 rpm, 144 rpm, 152 rpm, 160 rpm, 200 rpm, 250 rpm, or 300 rpm. In some embodiments, the speed can be less than or equal to 200 rpm, 192 rpm, 184 rpm, 176 rpm, 168 rpm, or 160 rpm. In some embodiments, the speed can fall within a range of 120 rpm to 300 rpm, or 128 rpm to 192 rpm, or 136 rpm to 184 rpm, or 144 rpm to 176 rpm, or 152 rpm to 168 rpm, or can be about 160 rpm. In some embodiments, the rotating basket 204 can rotate at a speed of 120 to 300 rpm.

In some embodiments, the rotating basket 204 can be rotated at a substantially consistent speed. However, in other embodiments, the rotating basket 204 may follow various patterns such as rotating at a first speed for a first period of time followed by rotating at a second speed for a second period of time. The second speed can be faster or slower than the first speed.

FIG. 2 shows snack products 210 disposed on the inner surface of the rotating basket 204. When the rotating basket 204 is rotating, the snack products 210 can be held in place by being pushed outward through centrifugal force. Snack food products 210 can enter the rotating basket 204 by first passing through a product input funnel 212 and then a product placement chute 214 positioned to place the snack food product at a desirable point along the inside surface of the rotating basket 204. After processing in the centrifuge air fryer 106, the snack food products can then exit through the bottom of the rotating basket 204 and onto an output conveyor 222. However, in some embodiments, snack food products can be removed through the top as part of a batch operating mode of the centrifuge air fryer 106. In some embodiments, the output conveyor 222 can carry the snack food products onward for further operations including one or more of seasoning, bagging, packaging, and the like.

The centrifuge air fryer 106 also includes a gas control system 216. The gas control system 216 can serve to control gaseous conditions within the centrifuge air fryer 106. Various compositions of gases can be used inside the centrifuge air fryer. In some embodiments, the composition of gases can be a typical atmospheric composition including nitrogen (78 vol. %), oxygen (21 vol. %), argon (0.93 vol. %), and carbon dioxide (0.04 vol. %). However, in some embodiments, the composition of gases can be amount to a reduced oxygen environment (e.g., where the amount of oxygen is less than would otherwise be normal atmospherically). In some embodiments, oxygen can be displaced by using a gas mixture that is lower in oxygen than typical atmospheric air or even a pure gas such as nitrogen. In some embodiments, steam injection can be used to displace oxygen content within the centrifuge air fryer 106. In some embodiments, the gaseous composition within the centrifuge air fryer can include less than about 20, 28, 26, 14, 12, 10, 8, 6, 4, 2, or less than 1 percent by volume oxygen, or an amount of oxygen falling within a range between any of the foregoing. In some embodiments, the gaseous composition within the centrifuge air fryer contains at least 80, 85, 90, 95, 98, or 99 percent by volume nitrogen, or an amount of nitrogen falling within a range between any of the foregoing.

Moisture content inside the centrifuge air fryer can also vary. In some embodiments, a moisture content in a gas in the centrifuge air fryer is atmospheric. In some embodiments, a moisture content in a gas in the centrifuge air fryer is less than atmospheric. In some embodiments, the relative humidity of the gaseous composition inside the centrifuge air fryer can be less than 90, 80, 70, 60, 50, 40, 30, 20, 15, 10, 5, 2, or 1 percent, or a relative humidity falling within a range between any of the foregoing. The overall pressure can also vary within the centrifuge air fryer. In some embodiments, an interior of the centrifuge air fryer is at atmospheric pressure (or approximately 760 mmHg at sea level). However, in some embodiments, an interior of the centrifuge air fryer is under vacuum (e.g., less than 760 mmHg). For example, the interior of the centrifuge air fryer can be at a total pressure of 750, 700, 650, 600, 550, 500, 450, 400, 350, 300, 250, 200, 150, 100 mmHg or less, or a value falling within a range between any of the foregoing.

The centrifuge air fryer 106 also includes a gas flow channel 218 which can provide for circulating air within the centrifuge air fryer 106. In an embodiment, the gas flow channel can push gas through at various speeds and into the area where the snack food products are held within the rotating basket 204. In some embodiments, gas can be moved through at a gas flow rate can be greater than or equal to 0.0, 0.5, 1.0, 1.5, 2.0, or 2.5 cfm. In some embodiments, the gas flow rate can be less than or equal to 6.0, 5.0, 4.0, 3.5, 3.0, or 2.5 cfm. In some embodiments, the gas flow rate can fall within a range of 0.0 to 6.0 cfm, or 0.5 to 5.0 cfm, or 1.0 to 4.0 cfm, or 1.5 to 3.5 cfm, or 2.0 to 3.0 cfm. In some embodiments, gas can be moved through at a gas flow rate of 1.0 to 4.0 cfm.

The centrifuge air fryer 106 can also include a control unit 220 that can send control signals to various components of the centrifuge air fryer 106 in order to control the operation thereof and, in some cases, the operation of other pieces of equipment described herein. The control unit 220 can include a control circuit which can include components such as one or more of a microcontroller, a microprocessor, an ASIC, or the like.

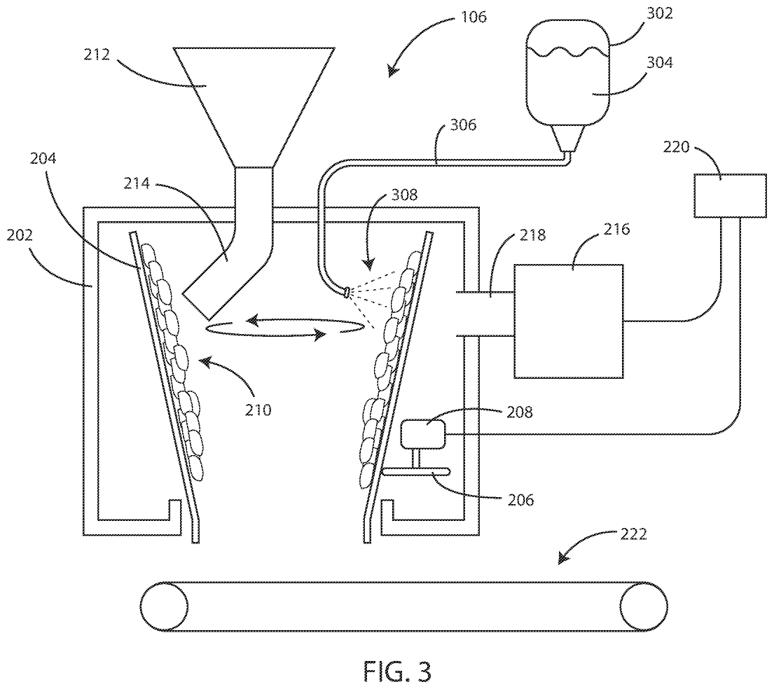

In some embodiments, a seasoning composition can be applied to the snack food products while the snack food products are within the centrifuge air fryer 106. Referring now to FIG. 3, a schematic view of centrifuge air fryer 106 is shown in accordance with various embodiments herein. As before, the centrifuge air fryer 106 includes a housing 202, a rotating basket 204, a drive mechanism 206, a drive motor 208, a product input funnel 212, a product placement chute 214, a gas control system 216, a gas flow channel 218, a control unit 220, and an output conveyor 222. In this embodiment, the centrifuge air fryer 106 also includes a seasoning reservoir 302 holding a flowable seasoning composition 304 therein. However, in other embodiments, a seasoning composition may not be flowable or may be powdered. The centrifuge air fryer 106 also includes a seasoning supply conduit 306 which can provide for a flow of seasoning composition into the centrifuge air fryer 106. In this embodiment, the seasoning composition is then applied to the snack product 210 as a seasoning spray 308. However, it will be appreciated that there are various techniques for applying a seasoning composition that are contemplated herein.

In some embodiments, various sensors can be used within, on, or adjacent to the centrifuge air fryer 106 in order to precisely control the operation thereof and the operations performed on the snack food products processed therein. In some embodiments, the centrifuge air fryer 106 can include one or more of a temperature sensor, a pressure sensor, a photo sensor, and the like. In some embodiments, characteristic color changes will occur to the snack food product as it is cooked in the centrifuge air fryer 106. Thus, in some embodiments herein, a photo sensor can be used to generate a signal that can then be processed/monitored by the control unit 220. Various factors, including the temperature and/or the residence time within the centrifuge air fryer 106 can be precisely controlled based, at least in part, on the signals received from the photo sensor.

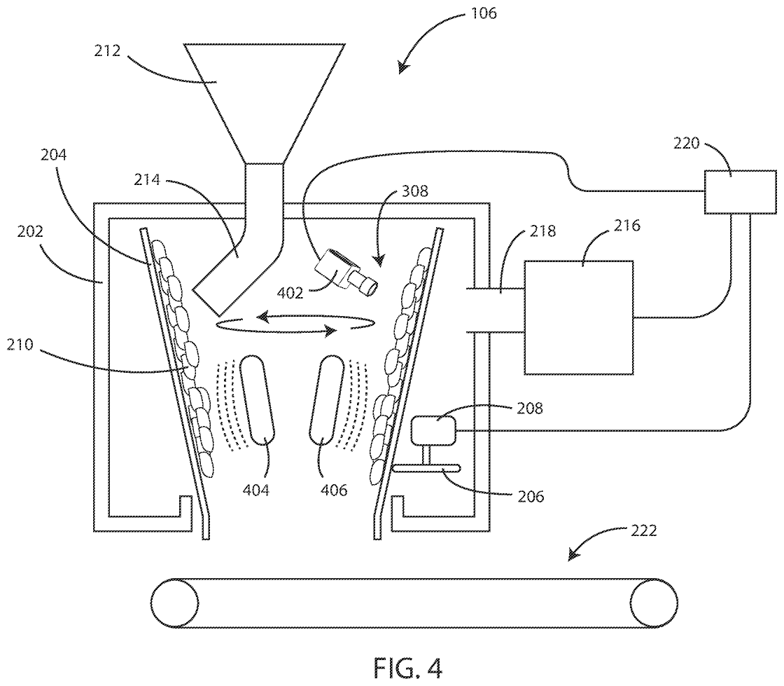

Referring now to FIG. 4, a schematic view of centrifuge air fryer 106 is shown in accordance with various embodiments herein. The components of the centrifuge air fryer 106 in FIG. 4 are generally similar to that depicted in FIG. 2. However, the centrifuge air fryer 106 shown in FIG. 4 also shows a photo sensor 402.

In some embodiments, other components can be included in the centrifuge air fryer 106 to assist in the cooking of snack food products therein. By way of example, in some embodiments, the centrifuge air fryer 106 can include an emitter or antenna 404, 406 for microwave or radiofrequency energy can be disposed within, on, or adjacent to the centrifuge air fryer 106 and configured to emit microwave and/or radiofrequency energy into the centrifuge air fryer 106 so as to assist in cooking the snack food products therein.

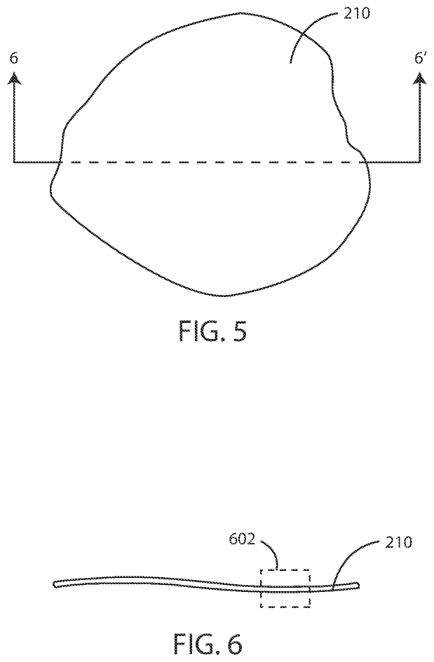

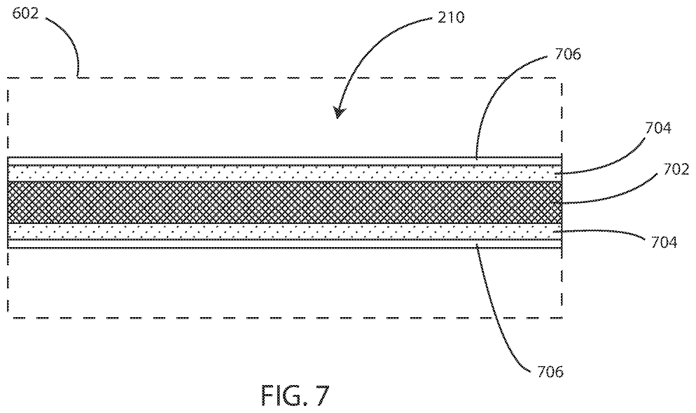

Referring now to FIG. 5, a plan view of a finished snack product 210 is shown in accordance with various embodiments herein. In particular, FIG. 5 depicts the snack product 210 as a potato chip. However, it will be appreciated that many other types of snack products are contemplated herein (as described further below). Referring now to FIG. 6, a cross-sectional view of a snack product 210 as taken along line 6-6′ of FIG. 5 is shown in accordance with various embodiments herein. The snack product 210 is depicted highlighting a portion 602 that is further enlarged and described in FIG. 7.

Referring now to FIG. 7, a cross-sectional view of the portion 602 of the snack food product is shown in accordance with various embodiments herein. FIG. 7 shows a portion 602 of a snack product 210. In this example, the snack product 210 includes a core zone 702, surface zones 704 disposed on opposite sides of the core zone 702, and a seasoning layer 706 disposed over the surface zones 704. Various properties can be different between the core zone 702 and the surface zones 704. By way of example, in some embodiments, the amount of oil can vary between the core zone 702 and the surface zones 704. In some embodiments, the surface zones 704 can include a heavier loading of oil than the core zone 702. In some embodiments, the density of the snack food product can vary between the core zone 702 and the surface zones 704.

The thickness of the different zones can vary. In some embodiments, the full thickness of the snack food product including the core zone 702, the surface zones 704 and the seasoning layers 706 can be about 0.2 to 3 millimeters. The total thickness of the surface zones 704 versus the core zone 702 can vary. In various embodiments, the total thickness of the surface zones 704 versus the core zone 702 can be in a ratio of 0.1:1, 0.2:1, 0.3:1, 0.4:1, 0.5:1, 0.75:1, 1:1, 1.5:1, 2:1, 3:1, 4:1, 5:1, 7.5:1, 10:1, or falling within a range between any of the foregoing ratios.

While not intending to be bound by theory, in some embodiments, it is believed that the centrifugal force that the snack food products are exposed to in the centrifuge air fryer 106 can release oil out of the surface zones 704. However, when a seasoning composition is applied, it can be pulled into the area previously evacuated by the oil. In other words, the process of extracting oil in the centrifuge air fryer 106 can lead to greater uptake of a seasoning composition akin to how a sponge that has been squeezed can more readily take up water than can a sponge that is already saturated. In embodiments where a seasoning composition is applied in the centrifuge air fryer 106, the system can include at least two operating modes. The first mode can be characterized by a higher rotation speed in order to extract as much oil from the snack food product as possible. The second mode can be characterized by a lower rotation speed to reduce centrifugal forces along with the application of a seasoning composition that can then be taken up by the snack food product.

### Air Fried Chip Characteristics

Air fried chips in accordance with embodiments herein offer substantial benefits in the form of positive sensory experiences associated with normally fried chips while being compositionally different. Air fried chips herein are distinguishable from normally fried chips in a variety of ways.

In some embodiments, air fried chips can have a higher starch content than otherwise similar conventionally prepared chips. By way of example, chips in accordance with embodiments herein can have a starch content (after the operation of frying the snack product in the centrifuge air fryer) greater than or equal to 30 wt. %, 35 wt. %, 40 wt. %, 45 wt. %, 50 wt. %, 55 wt. %, 60 wt. %, 65 wt. %, or 70 wt. %, or can be an amount falling within a range between any of the foregoing.

In some embodiments, air fried chips herein can have a number of pores per unit surface area less than otherwise similar conventionally prepared chips. While not intending to be bound by theory, pores can impact various aspects such as structural characteristics, crunch, oil retention, and the like. By way of example, in some embodiments, the total number of pores (after the operation of frying the snack product in the centrifuge air fryer) can be less than or equal to 750, 700, 650, 600, 550, 500, 450, 400, 350, 300, 250, 200, 150, or 100 pores per square millimeter (mm²), or can be an amount falling within a range between any of the foregoing. In some embodiments, the number of pores (after the operation of frying the snack product in the centrifuge air fryer) of less than median size can be less than or equal to 500, 450, 400, 350, 300, 250, 200, 150, or 100 pores per square millimeter (mm²), or can be an amount falling within a range between any of the foregoing.

In some embodiments, air fried chips herein can have lipid droplet sizes on the surface thereof that are smaller than otherwise similar conventionally fried chips. While not intending to be bound by theory, lipid droplet sizes can impact various aspects such as sensory properties, oil content, and the like. In some embodiments, the mean lipid droplet size (after the operation of frying the snack product in the centrifuge air fryer) can be less than or equal to 200, 175, 150, 125, 100, 75, or 50 micrometers squared (μm²), or can be an amount falling within a range between any of the foregoing.

### Methods

Many different methods are contemplated herein, including, but not limited to, methods of making, methods of using, and the like. Aspects of system/device operation described elsewhere herein can be performed as operations of one or more methods in accordance with various embodiments herein.

In an embodiment, a method of preparing a reduced fat fried snack product is included, the method preparing discrete units of a snack product, par frying the snack product in an oil fryer, wherein par frying the snack product in the oil fryer reduces moisture in the snack product to approximately 2 to 8 weight percent or to approximately 2 to 4 weight percent, and frying the snack product in a centrifuge air fryer, wherein frying the snack product in the centrifuge air fryer reduces moisture in the snack product to 1.5 to 2.5 weight percent and reduces fat content of the snack product to 12 to 38 weight percent or in some cases to 23 to 27 weight percent. In an embodiment of the method, the residence time in the centrifuge air fryer is greater than the residence time in the oil fryer. In some embodiments of the method the residence time in the oil fryer is from 2.5 to 9 minutes or from 3.5 to 5.5 minutes. In some embodiments of the method the residence time in the centrifuge air fryer is 0.5 to 8 minutes or from 5 to 7 minutes.

In an embodiment of the method, a gas temperature within the centrifuge air fryer is from 250 to 500 degrees Fahrenheit, or 300 to 400 degrees Fahrenheit, or in some embodiments from 360 to 400 degrees Fahrenheit. In an embodiment of the method, a gas temperature within the centrifuge air fryer is set at a first temperature for a first time period and is set at a second temperature for a second time period. In an embodiment of the method, a transition between the first temperature and the second temperature is a ramp. In an embodiment of the method, a transition between the first temperature and the second temperature is a step change.

In an embodiment of the method, an oil temperature in the oil fryer is from 265 to 400 degrees Fahrenheit or from 265 to 345 degrees Fahrenheit.

In an embodiment of the method, preparing discrete units of the snack product comprises slicing a food material. In an embodiment of the method, preparing discrete units of the snack product comprises sheeting and cutting a food material.

In an embodiment of the method, a gas within the centrifuge air fryer contains less than 1 percent by volume oxygen. In an embodiment of the method, a gas within the centrifuge air fryer contains at least 95 percent by volume nitrogen. In an embodiment of the method, a moisture content in a gas in the centrifuge air fryer is less than atmospheric.

In an embodiment of the method, an interior of the centrifuge air fryer is under vacuum.

In an embodiment, the method can further include applying a seasoning composition in the centrifuge air fryer. In an embodiment, the method can further include applying a seasoning composition after frying the snack product in the centrifuge air fryer.

In an embodiment, the method can further include precooking a component of the snack product prior to par frying the snack product in the oil fryer.

In an embodiment of the method, the centrifuge air fryer operates at a drum speed of 120 to 300 rpm. In an embodiment of the method, the centrifuge air fryer operates at a gas flow rate of 1.0 to 4.0 cfm.

In an embodiment, the method can further include exposing the discrete units of the snack product to a pulse electric field prior to par frying the snack product in the oil fryer.

In an embodiment of the method, the centrifuge air fryer includes a microwave or RF emitter.

In an embodiment of the method, the snack product has a starch content of greater than 50 wt. % after the operation of frying the snack product in the centrifuge air fryer. In an embodiment of the method, the snack product has less than 600 pores per millimeter squared of surface area after the operation of frying the snack product in the centrifuge air fryer. In an embodiment of the method, the snack product has a mean lipid droplet size of less than 100 micrometers squared on the surface thereof after the operation of frying the snack product in the centrifuge air fryer.

In an embodiment, a method of preparing a reduced fat fried snack product is included, the method preparing discrete units of a snack product, par frying the snack product in an oil fryer, wherein par frying the snack product in the oil fryer reduces moisture in the snack product to approximately 2 to 8 weight percent, frying the snack product in a centrifuge air fryer, wherein frying the snack product in the centrifuge air fryer reduces moisture in the snack product to 1.5 to 2.5 weight percent and reduces fat content of the snack product to 12 to 38 weight percent, and applying a seasoning composition to the snack product, wherein applying a seasoning composition to the snack product increases the fat content of the snack product to 33 to 38 weight percent.

In an embodiment of the method, the residence time in the oil fryer is from 2.5 to 9 minutes.

In an embodiment of the method, the residence time in the centrifuge air fryer is 0.5 to 8 minutes.

In an embodiment of the method, the residence time in the centrifuge air fryer is greater than the residence time in the oil fryer.

In an embodiment of the method, a gas temperature within the centrifuge air fryer is from 250 to 500 degrees Fahrenheit or from 300 to 400 degrees Fahrenheit.

In an embodiment of the method, a gas temperature within the centrifuge air fryer is set at a first temperature for a first time period and is set at a second temperature for a second time period.

In an embodiment of the method, a transition between the first temperature and the second temperature is a ramp.

In an embodiment of the method, a transition between the first temperature and the second temperature is a step change.

In an embodiment of the method, an oil temperature in the oil fryer is from 265 to 400 degrees Fahrenheit.

In an embodiment of the method, preparing discrete units of the snack product further comprises slicing a food material.

In an embodiment of the method, the food material comprises a potato.

In an embodiment of the method, the snack product is a potato chip.

In an embodiment of the method, preparing discrete units of the snack product further comprises sheeting and cutting a food material.

In an embodiment of the method, the food material comprises a masa-based dough.

In an embodiment of the method, the snack product is a tortilla chip.

In an embodiment of the method, a gas within the centrifuge air fryer contains less than 1 percent by volume oxygen.

In an embodiment of the method, a gas within the centrifuge air fryer contains at least 95% by volume nitrogen.

In an embodiment of the method, a moisture content in a gas in the centrifuge air fryer is less than atmospheric.

In an embodiment of the method, an interior of the centrifuge air fryer is under vacuum.

In an embodiment, the method can further include precooking a component of the snack product prior to par frying the snack product in the oil fryer.

In an embodiment of the method, the centrifuge air fryer operates at a drum speed of 120 to 300 rpm.

In an embodiment of the method, the centrifuge air fryer operates at a gas flow rate of 1.0 to 4.0 cfm.

In an embodiment, the method can further include exposing the discrete units of the snack product to a pulse electric field prior to par frying the snack product in the oil fryer.

In an embodiment of the method, the centrifuge air fryer includes a microwave or RF emitter.

### Seasoning Compositions and Application Thereof

A variety of seasoning (or flavoring) compositions can be applied to snack food products herein. Example seasoning compositions include oils, colorants, flavorings, and the like. In some embodiments, a seasoning composition includes a comestible oil. Comestible oils can include oils derived from animals or plants. Comestible oils include, but are not limited to, olive oil, sunflower oil, vegetable oil, canola oil, peanut oil, palm oil, coconut oil, corn oil, rendered animal fats, and the like.

Seasoning compositions can further include various solid materials such as comestible seasonings. Comestible seasonings can include, but are not limited to, edible salts, cheese flavorings, peppercorn solids, vegetable solids, fruit solids, meat solids, spices, natural flavorings, artificial flavorings, preservatives, and the like. Other coating compositions can include coloring agents. In some embodiments, seasoning compositions can specifically include hydrophobic materials. In some embodiments, seasoning compositions can include hydrophilic materials.

Various methods and mechanisms can be used to apply seasoning compositions to materials in the systems disclosed herein. For example, seasoning compositions can be applied by a sprayer, enrober, dip tank, tumbler, duster, and the like. In some embodiments, seasoning compositions can be applied to snack food products within the centrifuge air fryer. In some embodiments, seasoning compositions can be applied to snack food products after leaving the centrifuge air fryer.

### Snack Food Products

Various embodiments herein making snack food products. Further details about exemplary snack products are provided as follows. However, it will be appreciated that this is merely provided by way of example and that further variations are contemplated herein.

In some embodiments, the snack food product is a chip. The chip can be formed with vegetable or fruit material as a major component thereof. In some embodiments, the chip can include a slice or segment of vegetable or fruit material. In some embodiments, the chip can include a ground, mashed, or otherwise processed vegetable or fruit material that is then shaped into the form of a chip.

In various embodiments, the snack product is a tuber chip. In various embodiments, the snack product is a potato chip. In various embodiments, the snack product is a sweet potato chip.

In some embodiments, the snack product can be a chip that is formed from a dough or batter and then formed into the shape of a chip. For example, in some embodiments, the chip can be formed from a masa-based dough or batter. The masa-based dough or batter can include various components including corn, lime, water and the like. In various embodiments, the snack product is a tortilla chip.

Aspects may be better understood with reference to the following examples. These examples are intended to be representative of specific embodiments, but are not intended as limiting the overall scope of embodiments herein.

### EXAMPLES

### Example 1: Par-Frying and Centrifuge Cooking

Techniques of par-frying followed by centrifuge air frying as disclosed herein were examined. In specific, potatoes were sliced and then par-fried in a deep fryer at a temperature of 295 degrees Fahrenheit for a period of approximately 4.92 minutes. The potato chips were then placed in a centrifuge air fryer and spun at speeds of 60 rpm at a temperature of 350 degrees Fahrenheit for a period of 4.93 minutes. Moisture was assessed after both par frying as well as processing in the centrifuge air fryer.

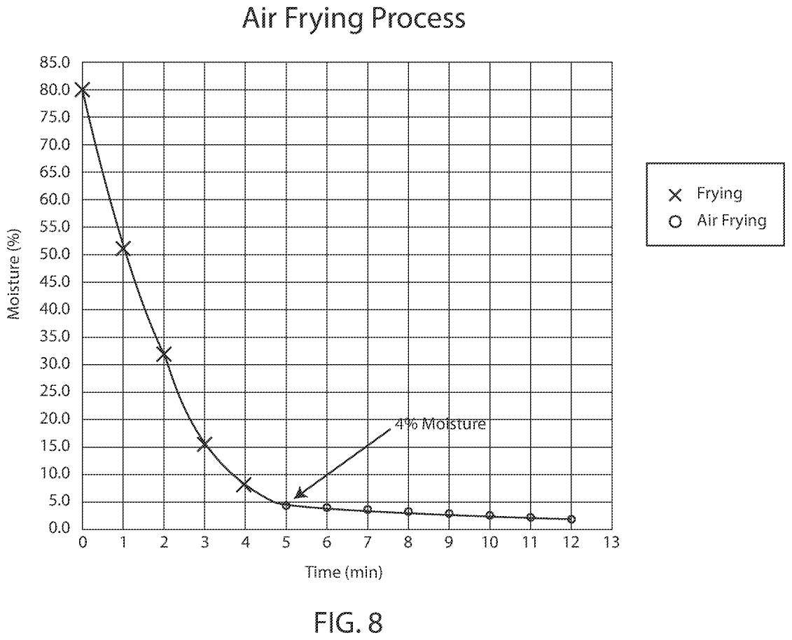

FIG. 8 is a graph showing moisture content of the potato chips versus time for the air fried chips. As can be seen, par frying lowered the moisture content to approximately 4 wt. percent and then it continued to be lowered as the cooking process continued in the centrifuge air fryer as evidenced by further lowering the moisture of the snack food product while oil was extracted.

### Example 2: Analysis of Air Fried Chips and Conventionally Fried Chips Using Nanotomography (Nano-CT)

The composition of multiple chips (including conventionally prepared chips and air-fried chips prepared in accordance with embodiments herein at two different time points—Air Fried Chip Sample #1 and Sample #2) were compared using nanotomography (Nano-CT) evaluated throughout the thickness of the chips. Relatively flat chips without a lot of visible breakage on the surface were chosen to be analyzed. Each chip was cut and put into a sample holder. Bubble wrap was placed in the top of the sample holder to prevent the chip from moving during the scan. Each chip was scanned on a Zeiss Versa 520 at 60 kV/5 W. Each chip was scanned at 2-3 microns/pixel at what was originally a cut edge of each chip.

The percent composition of each chip is shown below in TABLE 1:

TABLE 1

| | | | Late | Reduced | Air | Air |
|---|---|---|---|---|---|---|
| | | Regular | July | Fat | Fried | Fried |
| | Regular | Cape | Organic | Cape | Chip | Chip |
| | Kettle | Cod | Thin | Cod | Sample | Sample |
| | Chip | Chip | Chip | Chip | #1 | #2 |
| Oil | 38.3 | 19.4 | 19.4 | 29.9 | 13.2 | 26.9 |
| Starch | 36.1 | 30.4 | 23.6 | 46.5 | 70.4 | 65.2 |
| Air | 25.0 | 49.6 | 56.0 | 23.2 | 16.2 | 8.7 |
| Salt | 0.6 | 0.7 | 1.1 | 0.4 | 0.3 | 0.0 |

The Air Fried Chip Sample #1 and Sample #2 had overall less oil (13.2% and 26.9%) than the Regular Kettle Chip and Reduced Fat Cape Cod Chip (38.3% and 29.9%). And the Air Fried Chip Sample #1 also had less oil (13.2%) than the Regular Cape Cod Chip and Late July Organic Thin Chip (19.4% and 19.4%). This indicates air fried chips contain less oil than most conventionally fried chips.

The Air Fried Chip Sample #1 and Sample #2 had significantly more starch (70.4% and 65.2%) than the Regular Kettle Chip, Regular Cape Cod Chip, Late July Organic Thin Chip, and Reduced Fat Cape Cod Chip (30.4-46.5%). This indicates air fried chips contain significantly more starch than conventionally fried chips.

The Air Fried Chip Sample #1 and Air Fried Chip Sample #2 had significantly less air (16.2% and 8.7%) than the Regular Kettle Chip, Regular Cape Cod Chip, Late July Organic Thin Chip, and Reduced Fat Cape Cod Chip (23.2-56.0%). This indicates air fried chips contain significantly less air than conventionally fried chips.

The pore distribution of each chip was additionally measured. A 2×1 mm area of each chip was scanned. The pore count distribution of each chip is shown below in TABLE 2:

TABLE 2

| | | | Regular | Reduced | Air | Air |
|---|---|---|---|---|---|---|
| | | Regular | Late | Fat | Fried | Fried |
| | Regular | Cape | July | Cape | Chip | Chip |
| | Kettle | Cod | Organic | Cod | Sample | Sample |
| | Chip | Chip | Chip | Chip | #1 | #2 |
| Number | 2800 | 1400 | 850 | 1200 | 525 | 350 |
| of pores | | | | | | |
| Number | 850 | 550 | 350 | 750 | 250 | 200 |
| of lower | | | | | | |
| than | | | | | | |
| median | | | | | | |
| size pores | | | | | | |
| The | 35 | 63 | 28 | 30 | 10 | 10 |
| percent of | | | | | | |
| total area | | | | | | |
| of the | | | | | | |
| pores | | | | | | |

The Air Fried Chip Sample #1 and the Air Fried Chip Sample #2 had fewer pores (525 and 350) than the Regular Kettle Chip, Regular Cape Cod Chip, Regular Late July Organic Chip, and Reduced Fat Cape Cod Chip (850-2800). Additionally, the Air Fried Chip Sample #1 and the Air Fried Chip Sample #2 had fewer pores that were lower than the median pore size (250 and 200) compared to the Regular Kettle Chip, Regular Cape Cod Chip, Regular Late July Organic Chip, and Reduced Fat Cape Cod Chip (350-850). This indicates air fried chips contain fewer pores and more consistent pore sizes than conventionally fried chips.

The Air Fried Chip Sample #1 and the Air Fried Chip Sample #2 had fewer pores that made up the area of the total chip (10%) compared to than the Regular Kettle Chip, Regular Cape Cod Chip, Regular Late July Organic Chip, and Reduced Fat Cape Cod Chip (28-63%). This indicates air fried chips contain pores that are more centralized at one part of the chip than conventionally fried chips which contain pores that are more spread out across the surface of the chip.

### Example 3: Analysis of the Texture of Air Fried Chips and Conventionally Fried Chips

The texture of individual chips (including conventionally prepared chips and air-fried chips prepared in accordance with embodiments herein at two different time points—Air Fried Chip Sample #1 and Sample #2) was analyzed using a three-point bend test. The three-point bend test measures the hardness or crunch of the chip based on the maximum force (g) required to fracture the chip, the brittleness or fracturability of the chip based on the distance (mm) at which the chip begins to fracture, and the stiffness or toughness of the chip based on the energy required to completely fracture the chip (g/mm).

Each chip selected was whole and relatively flat with a diameter greater than 3 mm. Using the procedure described by Dueik, V., Robert, P., & Bouchon, P. (2010), each chip was supported using two parallel edges to apply the load centrally. The system was mounted in a TA.XT2 Texture Analyzer (Texture Technologies Corp.) using a support span of 16 mm. A 2.5 mm-thick steel blade with a flat edge was used to fracture each chip at a constant speed of 10 mm/s.

The texture of each chip is shown below in TABLE 3 (wherein hardness is in units of force (g), brittleness is in units of millimeters, and toughness is in units of g/mm):

TABLE 3

| | | | | Thick | | | | |
|---|---|---|---|---|---|---|---|---|
| | Thick | Thick | Thick | Cape | | Thin | Air | Air |
| | Kettle | Kettle | Cape | Cod | | Late | Fried | Fried |
| | Chip | Chip | Cod | Reduced | Thin | July | Chip | Chip |
| | Sample | Sample | Regular | Fat | Lays | Organic | Sample | Sample |
| | #1 | #2 | Chip | Chip | Chip | Chip | #1 | #2 |
| Hardness | 580 | 550 | 520 | 505 | 300 | 305 | 390 | 340 |
| Brittleness | 160 | 165 | 130 | 130 | 185 | 190 | 185 | 140 |
| Toughness | 395 | 340 | 405 | 380 | 180 | 170 | 205 | 250 |

The Thick Kettle Chip Sample #1, Thick Kettle Chip Sample #2, Thick Cape Cod Regular Chip, and Thick Cape Cod Reduced Fat Chip were all harder (505-580) than the Thin Lays Chip, Thin Late July Organic Chip, Thin Air Fried Chip Sample #1, and Thin Air Fried Chip Sample #2 (300-390). Additionally, the Thin Air Fried Chip Sample #1 and Thin Air Fried Chip Sample #2 were harder (390 and 340) than the Thin Lays Chip and Thin Late July Organic Chip (300 and 305). This suggests that air fried chips are less crunchy than conventionally fried thick chips but more crunchy than thinner conventionally fried chips.

The Thick Kettle Chip Sample #1, Thick Kettle Chip Sample #2, Thick Cape Cod Regular Chip, and Thick Cape Cod Reduced Fat Chip were more brittle (130-165) than the Thin Lays Chip, Thin Late July Organic Chip and Thin Air Fried Chip Sample #1 (185-190). However, the Thin Air Fried Chip Sample #1 and Thin Air Fried Chip Sample #2 had a similar brittleness (185 and 140) to the Thin Lays Chip, Thin Late July Organic Chip (185 and 190). This suggests that air fried chips are less brittle than thicker conventionally fried chips but similar in brittleness to thin conventionally fried chips.

The Thick Kettle Chip Sample #1, Thick Kettle Chip Sample #2, Thick Cape Cod Regular Chip, and Thick Cape Cod Reduced Fat Chip were tougher (340-405) than the Thin Lays Chip, Thin Late July Organic Chip, Thin Air Fried Chip Sample #1, and Thin Air Fried Chip Sample #2 (170-250). However, the Thin Air Fried Chip Sample #1 and Thin Air Fried Chip Sample #2 had a similar toughness (205 and 250) to the Thin Lays Chip, Thin Late July Organic Chip (180 and 170). This suggests that air fried chips are less tough than thicker conventionally fried chips but similar in toughness to thin conventionally fried chips.

### Example 4: Analysis of Air Fried Chips and Conventionally Fried Chips Using a Confocal Laser

The oil droplets and area of individual chips (including conventionally prepared chips and air-fried chips prepared in accordance with embodiments herein at two different time points—Air Fried Chip Sample #1 and Sample #2) on the surface thereof were analyzed using a confocal laser. An image of each chip was acquired on a Zeiss LSM880 confocal microscope with a 5×/0.25 objective lens with 30 ug/ml Nile Red (Sigma N-3013) and 1/100 diluted Calcofluor White (Sigma 18909) at a depth of 100 nm. The particular settings of the microscope used such as the laser intensities, PMT gains, pinholes, and scan speed were all contained within the meta data in the CZI files in the rawData folder and can be read out using Zeiss Zen software or ImageJ (FIJI version recommended).

The lipid droplet data is shown below in TABLE 4:

TABLE 4

| | Regular | Regular | Air Fried | Air Fried |
|---|---|---|---|---|
| | Kettle | Cape Cod | Chip Sample | Chip Sample |
| | Chip | Chip | #1 | #2 |
| Number of | 1048 | 1002 | 336 | 301 |
| lipid droplets | | | | |
| Lipid droplet | 1.30 | 1.44 | 0.36 | 0.27 |
| percent area | | | | |
| Mean size | 107.3 | 124.4 | 94.0 | 79.2 |
| (um²) | | | | |
| Standard | 3.6 | 8.3 | 5.5 | 4.4 |
| error of mean | | | | |
| (um²) | | | | |

The Air Fried Chip Sample #1 and Air Fried Chip Sample #2 had about ⅓ less lipid droplets (336 and 301) than the Regular Kettle Chip and Regular Cape Cod Chip (1048 and 1002). Additionally, the Air Fried Chip Sample #1 and Air Fried Chip Sample #2 had lipid droplets that were approximately 15-30% smaller (0.36 and 0.27) than the Regular Kettle Chip and Regular Cape Cod Chip (1.30 and 1.44). This indicates that air fried chips contain significantly less oil and less overall area of oil than conventionally fried chips.

### Example 5: Analysis of the Oil Content of Air Fried Chips and Conventionally Fried Chips

The oil content of conventionally fried chips and air-fried chips prepared in accordance with embodiments herein (Air Fried Chip) was evaluated. Specifically, the total oil content of each chip was measured along with the surface topical oil content and penetrated surface oil present in each chip. To measure the oil content, 8-10 g of full-sized chips were measured and 100 ml of ether was added for 20 seconds. The ether was poured off in a tared beaker and the surface topical oil was measured. The chips were then dried and ground in a mortar. The ground chips were then transferred to a beaker and the penetrated oil was extracted with 100 ml of ether. The extraction process was repeated twice more. The ether was then filtered through a funnel with glass wool and salt and collected in a tared beaker and the penetrated oil was measured.

The oil content data is shown below is TABLE 5:

TABLE 5

| | | | | | Air Fried |
|---|---|---|---|---|---|
| | | | | Air Fried | Chip vs. |
| | Regular | Reduced | Air | Chip vs. | Reduced |
| | Kettle | Fat Cape | Fried | Regular | Fat Cape |
| | Chip | Cod Chip | Chip | Kettle Chip | Cod Chip |
| Surface | 8.1 | 6.3 | 6.9 | −14.8 | 9.5 |
| Topical Oil | | | | | |
| (wt. %) | | | | | |
| Penetrated | 18.2 | 15.2 | 13.4 | −26.7 | −11.8 |
| Surface Oil | | | | | |
| (wt. %) | | | | | |
| Total Oil | 26.3 | 21.5 | 20.3 | −22.8 | −5.6 |
| (wt. %) | | | | | |

The Air Fried Chip had 15% less surface oil than the Regular Kettle Chip but 9.5% more surface oil than the Reduced Fat Cape Cod Chip. This indicates that air fried chips have less surface oil than conventionally fried chips but more surface oil than reduced fat chips. This suggests that air fried chips have a sensory experience similar to conventionally fried chips.

The Air Fried Chip had 26.7% less penetrated oil than the Regular Kettle Chip and −11.8% less penetrated oil than the Reduced Fat Cape Cod Chip. This indicates that air fried chips contain less penetrated oil than conventionally fried chips and thus are a lower fat chip.

### Example 6: Analysis of the Oxidative Stability of Air Fried Chips and Conventionally Fried Chips

The oxidative stability of air fried chips (Air Fried Chip Sample #1 and Sample #2) and conventionally fried chips was analyzed. The oxidative stability was determined by Rancimat which converts oxidative products into acidic form for measurement. An air stream was passed through the chip sample at 110° C. causing the oxidation of the sample chip in volatile organic compounds. The volatile organic compounds were transferred to a measuring vessel and absorbed into a measuring solution of distilled water. The time until the appearance of these volatile organic compounds was recorded. The time until the appearance of volatile compounds is referred to as the induction period which is indicative of the oxidation stability of the sample chip.

The oxidative stability of the Air Fried Chip Sample #1 and the Air Fried Chip Sample #2 were compared to the Reduced Fat Cape Cod Chip at 110° C. It was found the Air Fried Chip Sample #1 and the Air Fried Chip Sample #2 had comparable oxidative stabilities to the Reduced Fat Cape Cod Chip. For example, it was found that Air Fried Chip Sample #2 had an average induction period of 23.81 hours and the Reduced Fat Cape Cod Chip had an average induction period of 23.48 hours. This indicates that air fried chips have a similar shelf life to reduced fat conventionally fried chips of about 18 weeks.

The volatile compound, hexanal was compared in the Air Fried Chip Sample #2 and the Reduced Fat Cape Cod Chip. It was found that the levels of hexanal present in the Air Fried Chip Sample #2 stayed low until 18 weeks. In contrast, the levels of hexanal present in the Reduced Fat Cape Cod Chip stayed low until 12 weeks. This indicates air fried chips remain stable longer than reduced fat conventionally fried chips.

The volatile compounds, butanals and pyrazines were compared in the Air Fried Chip Sample #2 and the Reduced Fat Cape Cod Chip. It was found that the Air Fried Chip Sample #2 had higher levels of butanals and pyrazines throughout its 18-week shelf life compared to the Reduced Fat Cape Cod Chip. This indicates air fried chips contain more desirable roasted flavors throughout their shelf-life compared to reduced fat conventionally fried chips. It is suggested higher levels of roasted flavors are desirable as it provides a similar taste profile to conventionally fried chips.

Lastly, the sweet or floral flavor compounds and the potato flavor compounds were compared in the Air Fried Chip Sample #2 and the Reduced Fat Cape Cod Chip. It was found that the Air Fried Chip Sample #2 had higher levels of sweet and potato flavor compounds throughout its 18-week shelf-life compared to the Reduced Fat Cape Cod Chip. This indicates air fried chips maintain higher levels of desirable sweet and potato flavors throughout their shelf-life compared to reduced fat conventionally fried chips. It is suggested higher levels of sweet and potato flavors are desirable as it provides a similar taste profile to conventionally fried chips.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A method of preparing a reduced fat fried snack product comprising:
preparing discrete units of a snack product;
par frying the snack product in an oil fryer, wherein par frying the snack product in the oil fryer reduces moisture in the snack product to approximately 2 to 8 weight percent; and
frying the snack product in a centrifuge air fryer, wherein frying the snack product in the centrifuge air fryer reduces moisture in the snack product to 1.5 to 2.5 weight percent and reduces fat content of the snack product to 12 to 38 weight percent.

2. The method of claim 1, wherein the residence time in the oil fryer is from 2.5 to 9 minutes.

3. The method of claim 1, wherein the residence time in the centrifuge air fryer is 0.5 to 8 minutes.

4. The method of claim 1, wherein the residence time in the centrifuge air fryer is greater than the residence time in the oil fryer.

5. The method of claim 1, wherein a gas temperature within the centrifuge air fryer is from 250 to 500 degrees Fahrenheit.

6. (canceled)

7. The method of claim 1, wherein a gas temperature within the centrifuge air fryer is set at a first temperature for a first time period and is set at a second temperature for a second time period.

8-9. (canceled)

10. The method of claim 1, wherein an oil temperature in the oil fryer is from 265 to 400 degrees Fahrenheit.

11. The method of claim 1, wherein preparing discrete units of the snack product further comprises slicing a food material.

12. (canceled)

13. The method of claim 1, wherein the snack product is a potato chip.

14-15. (canceled)

16. The method of claim 1, wherein the snack product is a tortilla chip.

17-19. (canceled)

20. The method of claim 1, wherein an interior of the centrifuge air fryer is under vacuum.

21-22. (canceled)

23. The method of claim 1, further comprising precooking a component of the snack product prior to par frying the snack product in the oil fryer.

24. (canceled)

25. The method of claim 1, wherein the centrifuge air fryer operates at a gas flow rate of 1.0 to 4.0 cfm.

26. The method of claim 1, further comprising exposing the discrete units of the snack product to a pulse electric field prior to par frying the snack product in the oil fryer.

27. The method of claim 1, wherein the centrifuge air fryer includes a microwave or RF emitter.

28. The method of claim 1, wherein the snack product has a starch content of greater than 50 wt. % after the operation of frying the snack product in the centrifuge air fryer.

29. The method of claim 1, wherein the snack product has less than 600 pores per millimeter squared of surface area after the operation of frying the snack product in the centrifuge air fryer.

30. The method of claim 1, wherein the snack product has a mean lipid droplet size of less than 100 micrometers squared on the surface thereof after the operation of frying the snack product in the centrifuge air fryer.

31. A method of preparing a reduced fat fried snack product comprising:
preparing discrete units of a snack product;
par frying the snack product in an oil fryer, wherein par frying the snack product in the oil fryer reduces moisture in the snack product to approximately 2 to 8 weight percent;
frying the snack product in a centrifuge air fryer, wherein frying the snack product in the centrifuge air fryer reduces moisture in the snack product to 1.5 to 2.5 weight percent and reduces fat content of the snack product to 12 to 38 weight percent; and
applying a seasoning composition to the snack product, wherein applying a seasoning composition to the snack product increases the fat content of the snack product to 33 to 38 weight percent.

32-59. (canceled)

60. An air fried snack product comprising:
moisture of 1.5 to 2.5 wt. %;
fat content of 12 to 38 wt. %;
a starch content of greater than 50 wt. %;
less than 600 pores per mm² of surface area; and
a mean lipid droplet size of less than 100 mm² on the surface thereof.

61-64. (canceled)
